(19) United States
(12) Patent Application Publication
(10) Pub. No.: US 2025/0144451 A1
(43) Pub. Date: May 8, 2025

(54) INDICATOR APPARATUS FOR INDICATING AN EGRESS POINT

(71) Applicant: Eric FICK, Innisfil (CA)

(72) Inventor: Eric FICK, Innisfil (CA)

(21) Appl. No.: 18/502,211

(22) Filed: Nov. 6, 2023

(51) Int. Cl. A62B 3/00

(52) U.S. Cl. CPC A62B 3/00

(57) ABSTRACT

An indicator apparatus for indicating an egress point of a building is provided. The indicator apparatus includes an indicator light, and a connector member with first and second ends, at least one connector element and a manipulatable member, where the connector element is used for securing at least part of the connector member in a position such at least a portion of the connector member forms a continuous loop. The indicator apparatus also includes a releasable securing element that is connected to the connector member for securing the manipulatable member in a stowage configuration. The connector member being formed such that when the manipulatable member is in a use configuration, the manipulatable member can be fed through the egress point of the building so that the indicator light indicates the egress point.

### FIELD OF THE DISCLOSURE

The present disclosure relates generally to navigation tools for navigating within buildings and in particular, to an indicator apparatus for indicating an egress point of a building.

### BACKGROUND OF THE DISCLOSURE

In firefighting, it is common practice for firefighters to set up a ladder at an egress point so as to provide a means of egress for firefighters and/or potential victims. There are currently no good means by which a particular egress point can be indicated to the firefighter or potential victims once the firefighter is inside the building. This presents several critical safety concerns for firefighters when in a burning building. Fires within buildings produce exceptionally low visibility environments, making it challenging or nearly impossible for firefighters to know the location of various egress points of a building, let alone which of these various egress points has a ladder nearby that can be used to exit via the egress point. Attempting to locate suitable egress points becomes particularly difficult for victims when they are disoriented due to smoke, or are injured. It is critical for firefighters and/or victims to be able to determine the location of suitable egress points from a building.

There are also no good means by which firefighters can be provided with a clear indication of a path to safety if they are forced to use a different egress point than the one through which they entered the building. In responding to fire, firefighters will sometimes patrol the exterior of a building and force open any locked or blocked doors to provide additional points of egress for those inside. However, once unlocked, these doors must immediately shut to prevent the infiltration of air (and oxygen) that could further stoke the fire within the building. As a consequence, there is no way for firefighters within burning buildings to know or quickly determine just by looking at a particular closed door if that door is unlocked and can be used as a point of egress from the building.

### SUMMARY OF THE DISCLOSURE

According to an aspect, there is provided an indicator apparatus that is used for indicating an egress point of a building, the indicator apparatus comprising a connector member that includes a first end and a second end that is releasably connectable to the first end for forming a continuous loop from at least a portion of the connector member, at least part of the connector member being manipulatable between a stowage configuration where the connector member has a first length, and a use configuration where the connector member has a second length that is greater than the first length, a releasable securing element that is connected to the connector member for securing the segment of the connector member in the stowage configuration, and an indicator light that is connected to the connector member for indicating the position of the egress point.

According to an additional aspect, there is provided an indicator apparatus for placing through an egress point of a building to indicate the location of at least one person therewithin, the indicator apparatus comprising: a connector member that includes a first end and a second end that is releasably connectable to the first end for forming a continuous loop from at least a portion of the connector member, at least part of the connector member being manipulatable between a stowage configuration where the connector member has a first length, and a use configuration where the connector member has a second length that is greater than the first length, a releasable securing element that is connected to the connector member for securing the at least part of the connector member in the stowage configuration, and an indicator light that is connected to the connector member for indicating the position of the egress point.

### BRIEF DESCRIPTION OF THE DRAWINGS

Embodiments will now be described, by way of example only, with reference to the attached Figures, wherein:

FIG. 1 is a perspective view of the indicator apparatus according to an embodiment of the present disclosure, where the indicator apparatus includes a pair of straps and a pair of connector elements;

FIG. 2 is a perspective view of the embodiment of the indicator apparatus in FIG. 1, where the manipulatable member is in a use configuration and the first and second ends of the connector member are releasably connected;

FIG. 3 is a perspective view of the embodiment of the indicator apparatus in FIG. 1, where the manipulatable member is in a stowage configuration and the first and second ends of the connector member are releasably connected;

FIG. 4 is a side view of an additional embodiment of the indicator apparatus, where the indicator apparatus includes a single connector element in the form of a carabiner connected to one end of the manipulatable member;

FIG. 5 is a side view of the embodiment of the indicator apparatus of FIG. 4, where the carabiner is in an open position;

FIG. 6 is a perspective view of the embodiment of the indicator apparatus in FIG. 4, where the carabiner is releasably connected to the manipulatable member;

FIG. 7 is a straight-on of an additional embodiment of the indicator apparatus, where the indicator apparatus includes a cinchable loop;

FIG. 8 is a schematic diagram of the use of the embodiment of the indicator apparatus in FIG. 3, where the indicator apparatus is looped around a rung of a ladder positioned near a window; and

FIG. 9 is a schematic diagram of the use of the embodiment of the indicator apparatus in FIG. 3, where the indicator apparatus is looped around a door knob.

### DETAILED DESCRIPTION OF THE EMBODIMENTS

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures, and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description. It will also be noted that the use of the term “a” or “an” will be understood to denote “at least one” in all instances unless explicitly stated otherwise or unless it would be understood to be obvious that it must mean “one”.

As used herein, the terms “comprises” and “comprising” are to be construed as being inclusive and open ended, and not exclusive. Specifically, when used in the specification and claims, the terms “comprises” and “comprising”, and variations thereof mean the specified features, steps or components are included. These terms are not to be interpreted to exclude the presence of other features, steps, or components.

As used herein, the terms “about” and “approximately” are meant to cover variations that may exist in the upper and lower limits of the ranges of values, such as variations in properties, parameters, and dimensions.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The embodiments described herein are exemplary (e.g., in terms of materials, shapes, dimensions, and constructional details) and do not limit by the claims appended hereto and any amendments made thereto. Persons skilled in the art will appreciate that there are yet more alternative implementations and modifications possible, and that the following examples are only illustrations of one or more implementations. The scope of the disclosure, therefore, is only to be limited by the claims appended hereto and any amendments made thereto.

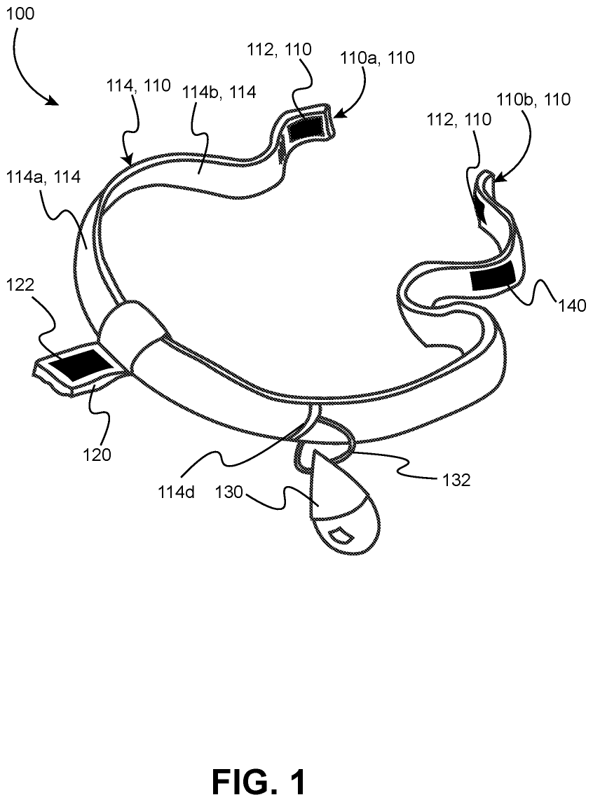

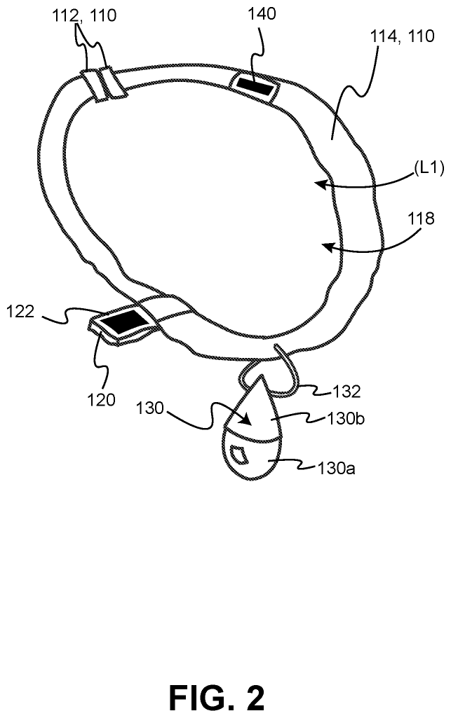

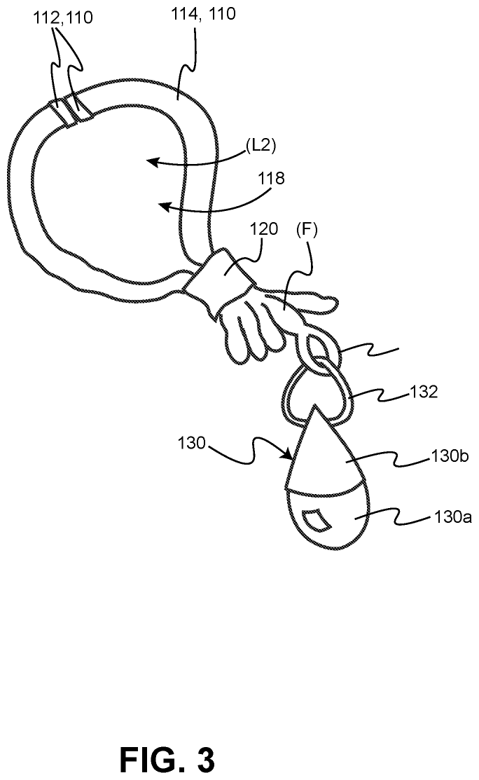

Referring to FIGS. 1 to 6, an embodiment of an indicator apparatus 100 that is used for indicating an egress point of a building is shown. The indicator apparatus 100 includes a connector member 110 that includes a first end 110a, and a second end 110b that is releasably connectable to the first end 110a for forming a continuous loop 118 from at least a portion of the connector member 110. At least part of the connector member 110 is manipulatable between a stowage configuration (see FIG. 3) where the connector member 110 has a first length, and a use configuration (see FIG. 2) where the connector member 110 has a second length that is greater than the first length. The indicator apparatus 100 also includes a releasable securing element 120 that is connected to the connector member 110 for securing the at least part of the connector member 110 in the stowage configuration, and an indicator light 130 that is connected to the connector member 110 for indicating the position of the egress point.

The indicator apparatus 100 as disclosed herein addresses several critical safety concerns for firefighters when fighting fires. The indicator apparatus 100 address the problem of low visibility within burning building environments by providing the indicator light 130. The indicator apparatus 100 is structured to include and/or form the continuous loop 118 of the at least part of the connector member 110, where the continuous loop 118 can be secured around various egress points of a building to provide a clear indication of a path to safety for a firefighter.

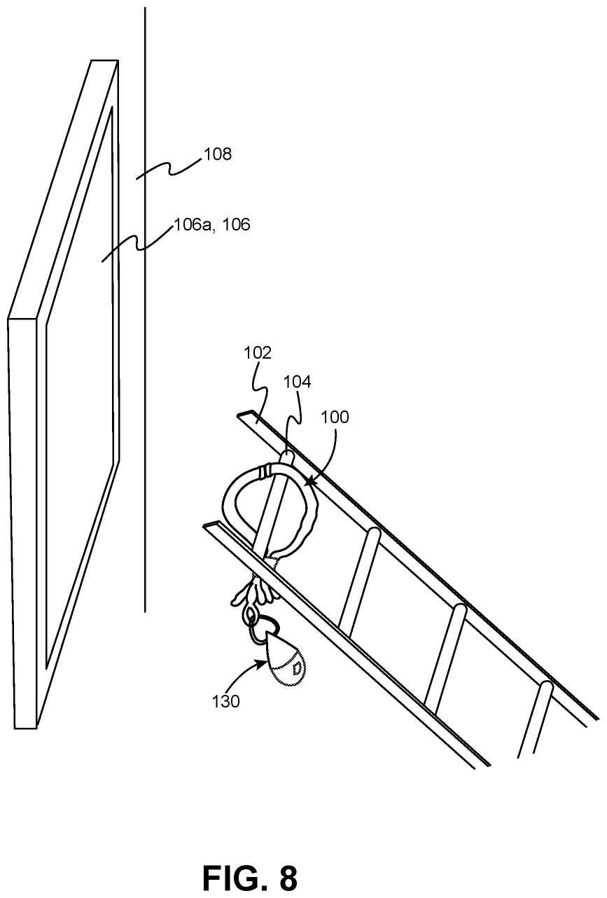

In one exemplary embodiment of use for the indicator apparatus 100 which is shown in FIG. 8, the indicator apparatus 100 can be looped around a rung 104 of a ladder 102 that is positioned near a window 106a of a building 108, and then fed through the window 106a such that the indicator light 130 is visible from the inside of the building 108, proximate the window 106a. The indicator apparatus 100 can then clearly indicate the ladder egress point 106 within the building 108 and is particularly beneficial in situations where escape would otherwise be difficult or impossible.

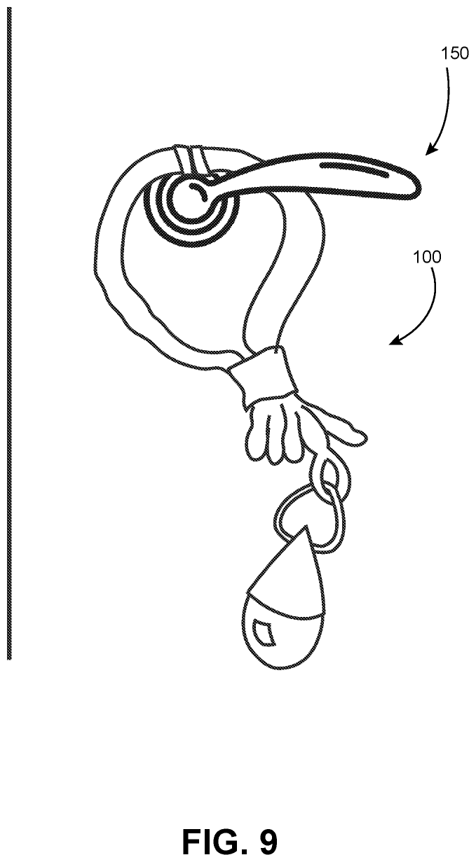

In an additional exemplary embodiment of use for the indicator apparatus 100 which is shown in FIG. 9, the indicator apparatus 100 can be looped around a doorknob or door handle 150 for indicating entry and exit points within the building 108. By indicating these entry and exit points, firefighters within the building 108 are able to quickly locate and access the entry and exit points. This functionality of the indicator apparatus 100 can save valuable time during rescue operations, ensuring that firefighters can reach victims quickly and effectively. When firefighters patrol the exterior of a burning building to find and unlock the doors of the building 108, the indicator light 130 of the indicator apparatus 100 as disclosed herein can then be turned on and placed around the door knob or door handle 150 of the doors once the doors are shut to prevent more oxygen from entering the building 108. In this way, the indicator apparatus 100 can notify firefighters in the interior of the building 108 that a particular door has been unlocked and can be used to exit the building 108.

In an embodiment such as shown in FIGS. 1 to 7, the connector member 110 includes at least one connector element 112 and a manipulatable member 114. The connector member 110 is structured such that the at least part of the connector member 110 which is manipulatable between the stowage and use configurations is the manipulatable member 114. Said another way, in this embodiment of the connector member 110, the manipulatable member 114 is the manipulatable part of the indicator apparatus 100 that can be manipulated between the stowage and use configurations.

In an embodiment of the connector member 110, at least the manipulatable member 114 component of the connector member 110 is composed of a highly reflective material to improve the visibility of the indicator apparatus 100.

In an additional embodiment, the manipulatable member 114 is composed of a length of a manipulatable material that is formed as one of a strap, a belt, or a rope. The material of the manipulatable member 114 can be any material that is suitably manipulatable, such as nylon fabric.

In an additional embodiment of the connector member 110, at least the manipulatable member 114 is composed of and/or coated with a fire-retardant material to prevent or substantially limit the risk of the indicator apparatus 100 igniting when in proximity to a fire.

In the specific embodiment provided in FIG. 1, the manipulatable member 114 is composed of a length of foldable fabric material and has a pair of substantially flat sides 114a, 114b.

In another additional embodiment such as shown in FIGS. 1 to 7, the indicator apparatus 100 also includes a rigid looped member 132 that is attached to the connector member 110, where the indicator light 130 is connected to the connector member 110 loop via the rigid looped member 132.

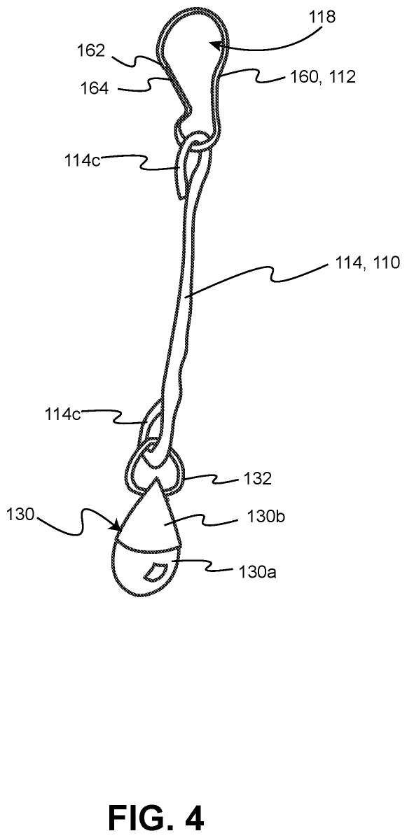

In an additional embodiment of the connector member 110 shown in FIGS. 4 to 6, the manipulatable member 114 of the connector member 110 includes end loops 114c formed on opposing first and second ends of the manipulatable member 114.

In some embodiments of the present disclosure, the connector member 110 is structured to facilitate easier attachment of the releasable securing element 120 to the connector member 110 for retaining the at least a portion of the connector member 110 in the stowage position. In an embodiment such as provided in FIGS. 1 to 3 and 7, the connector member 110 includes a securing part 140 that positioned along the length of the connector member 110, away from the releasable securing element 120. The securing part 140 is structured such that the releasable securing element 120 can be releasably connectable to the securing part 140 for securing the at least part of the connector member 110 in the stowage configuration.

In the specific embodiment provided in FIGS. 1 to 3, the releasable securing element 120 is a Velcro securing flap 122 that is secured around a length of a length of the manipulatable member 114 of the connector member 110, and the securing part 140 is a length of Velcro that is secured along a section of the manipulatable member 114, away from the Velcro securing flap 122.

While the above embodiment is described with specific reference to Velcro connections, various other types of securable elements may be provided as the releasable securing element 120 and securing part 140.

In the specific embodiments provided in FIGS. 2 and 3, the stowage configuration of the manipulatable member 114 is a folded configuration where the manipulatable member 114 includes at least one-fold (F), and the use configuration of the manipulatable member 114 is an unfolded configuration where the entirety of the manipulatable member 114 defines the continuous loop 118 of the connector member 110.

In an embodiment of the indicator apparatus 100, the indicator apparatus 100 is structured as a small-profile, relatively lightweight indicator apparatus 100 that can be easily stored and carried within a fire truck, or on the turnout gear of a firefighter. The small-profile and lightweight design of the indicator apparatus 100 makes the indicator apparatus 100 easy to store and carry, thereby helping to ensure that that firefighters will have the indicator apparatus 100 on hand when needed.

In an embodiment, the indicator light 130 of the indicator apparatus 100 is structured as a twistable indicator light 130 that includes an indicator light bulb 130a and a light housing 130b. The indicator light bulb 130a is rotatably mounted to the light housing 130b and can be twisted in opposing directions about the light housing 130b for switching the indicator light 130 on and off.

In an embodiment such as shown in FIGS. 1 to 3 and 7, the indicator light 130 is connected to the connector member 110 loop via the rigid looped member 132.

In an alternate embodiment such as shown in FIGS. 4 to 6, the indicator light 130 is connected through the end loop on the second end of the manipulatable member 114. In the specific embodiment shown in FIGS. 4 to 6, the rigid looped member 132 is looped through the end loop on the second end of the manipulatable member 114, and the indicator light 130 is connected to the rigid looped member 132.

In an additional embodiment, the indicator light 130 is detachable from the connector member 110.

As discussed above, some embodiment of the indicator apparatus 100 are structured for use on a rung of a ladder that is positioned proximate an egress point of a building, where the continuous loop 118 of the indicator apparatus 100 can be looped around the rung of a ladder that is positioned near an egress point of a building, and then fed through the egress point. In the specific, exemplary embodiment provided in FIG. 8, the egress point is a window of a building. The indicator apparatus 100 is looped around the rung of the ladder such that the continuous loop 118 of the connector member 110 is attached around the rung, while the manipulatable member 114 is held in the stowage configuration. In order to use the indicator apparatus for indicating the egress point of the building, the releasable securing element 120 is released and the manipulatable member 114 is manipulated from the stowage position to the use position. In the use position, the manipulatable member 114 can then be extended out and fed into the egress point of the building along with the indicator light 130.

In an alternative embodiment, the indicator apparatus 100 is structured for use in indicating an entry/egress point of the building to firefighters who are positioned outside the building. In some situations, it may be necessary for firefighters within a building to be able to indicate what entry/egress points they have used/are going to use to firefighters positioned outside the building. It may also be necessary for the firefighters within the building to indicate what room of a building they are in to the firefighters positioned outside the building. In this embodiment, the continuous loop 118 of the connector member 110 (which is formed by securing the first and second ends 110a, 110b of the connector member 110) is formed for securing to an object within a room of the building, and is sized such that when the continuous loop 118 of the connector member 110 is fixed to the object and the at least part of the connector member 110 is in the use configuration, the indicator apparatus 100 can be fed out a window of the room such that the indicator light 130 hangs down from the window and is visible to firefighters positioned outside of the building.

In the embodiments where the indicator apparatus 100 is structured such that the indicator light 130 can be positioned outside of the building, it can be said that the indicator apparatus 100 is for placing through the egress point of the building to indicate the location of at least one person therewithin. In these embodiments, the indicator apparatus still includes the connector member 110 that includes the first end 110a, and the second end 110b that is releasably connectable to the first end 110a for forming the continuous loop 118 The at least part of the connector member 110 is manipulatable between the stowage configuration where the connector member 110 has a first length, and the use configuration where the connector member 110 has a second length that is greater than the first length. The indicator apparatus 100 also includes the releasable securing element.

In an embodiment such as shown in FIGS. 1, 2, and 7 the indicator apparatus 100 is structured such that the continuous loop 118 of the connector member 110 is formed from, and defined by, at least part of the manipulatable member 114. In this embodiment, the first and second ends of the connector member 110 are defined on opposing ends of the manipulatable member 114; and the at least one connector element 112 is connected to at least one of the opposing ends of the manipulatable member 114.

In the specific embodiment of the at least one connector shown in FIGS. 1, 2 and 3, the at least one connector element 112 includes a first connector positioned proximate the first end of the manipulatable member 114 and a second connector positioned proximate the second end of the manipulatable member 114.

In the embodiment of the indicator apparatus 100 shown in FIGS. 1 to 3 and 7, the continuous loop 118 of the connector member 110 is formed from at least part of the manipulatable member 114, and the at least one connector element 112 is connected to at least one of the opposing first and second ends of the manipulatable member 114 for releasably connecting the opposing ends of the manipulatable member 114 when forming the continuous loop 118 of the connector member 110. The manipulatable member 114 is sized such that in the use configuration, the continuous loop 118 of the connector element 112 can be looped around the rung of the ladder and the indicator light 130 can be fed into the egress point 106 of the building 108. In this same embodiment, the releasable securing element 120 is positioned along the connector member 110 such that when the opposing ends of the manipulatable member 114 are connected via the at least one connector element 112, and the manipulatable member 114 is in the stowage configuration, the form of the manipulatable member 114 includes a first looped segment (L1) that can be looped around the rung 104 of the ladder 102. The releasable securing element 120 is also positioned such that when the opposing ends of the manipulatable member 114 are connected and the manipulatable member 114 is in the use configuration, the form of the manipulatable includes a second looped segment (L2) having a size that is greater than a size of the first looped segment (L1) such that the second looped segment (L2) can be looped around the rung 104 of the ladder 102 and fed at least partially into the egress point 106 of the building 108. The releasable securing element 120 is positioned on the connector member 110 such that in the stowage configuration, the first looped segment (L1) of the manipulatable member 114 will fit around a rung of the ladder, and in the use configuration, the second looped segment (L2) of the manipulatable member 114 will also fit around the rung of the ladder. In this way, the first looped segment (L1) defines the continuous loop 118 of the connector member 110 in the stowage configuration, and the second looped segment (L2) defines the continuous loop 118 of the connector member 110 in the use configuration.

In an additional embodiment such as shown in FIGS. 2 and 3, the releasable securing element 120 is positioned on the connector member 110 such that in the stowage configuration, the opposing first and second ends of the manipulatable member 114 are positioned along the first looped segment (L1) of the manipulatable member 114, and in the use configuration, the opposing first and second ends of the manipulatable member 114 are also positioned along the second looped segment (L2) of the connector member 110. In this way, either the first looped segment (L1) or second looped segment (L2) can be looped on the rung of the ladder by separating the opposing first and second ends of the manipulatable member 114 (i.e., the first and second ends of the connector member 110), and then connecting the first and second ends of the manipulatable member 114 together around opposing sides of the rung 104 of the ladder 102.

In an exemplary embodiment such as shown in FIG. 1, the manipulatable member 114 is composed of a pair of straps that each include a set of opposing ends, and the at least one connector is a pair of connector elements 112. One end of each of the pair of straps is fixed together to form a seam 114d, while the other end of each of the pair of straps includes one of the pair of connector elements 112 attached thereto. In the specific embodiment shown in FIG. 1, each of the pair of connector elements 112 is formed as a Velcro strap, where the Velcro straps on the ends of the pair of straps are complementary such that the ends of the pair of straps can be releasably connected for forming the continuous loop 118 of connector member 110 from the manipulatable member 114.

In another, additional embodiment shown in FIG. 2, the manipulatable member 114 of the connector member 110 is structured such that in the use configuration, the entirety of the manipulatable member 114 defines the continuous loop 118 of the connector member 110 and the second looped segment (L2) is defined by the entirety of the continuous loop 118 of the connector member 110.

In an alternate embodiment of the indicator apparatus 100 where the continuous loop 118 of the connector member 110 is formed from at least part of the manipulatable member 114, the at least one connector element 112 is a single connector element 112 that is structured to be releasably connected to a portion of the manipulatable member 114 that is spaced apart from the single connector element 112. In releasably connecting the single connector element 112 to the portion of the manipulatable member 114, the continuous loop 118 of the connector member 110 is formed from at least part of the manipulatable member 114 that loops from the single connector element 112 to the portion of the manipulatable member 114 on which the single connector element 112 is connected.

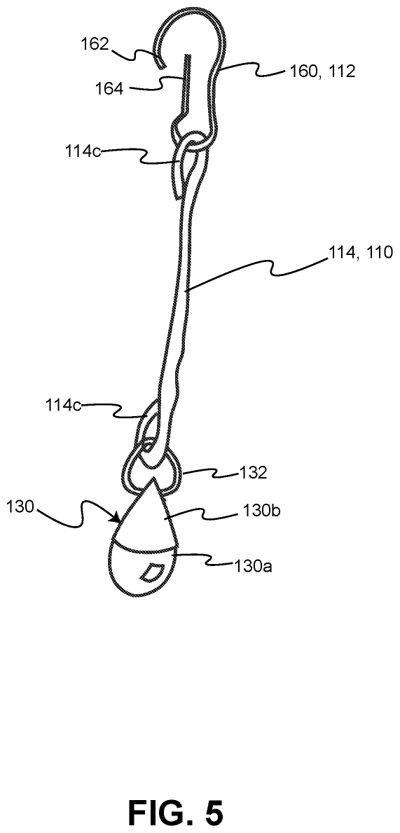

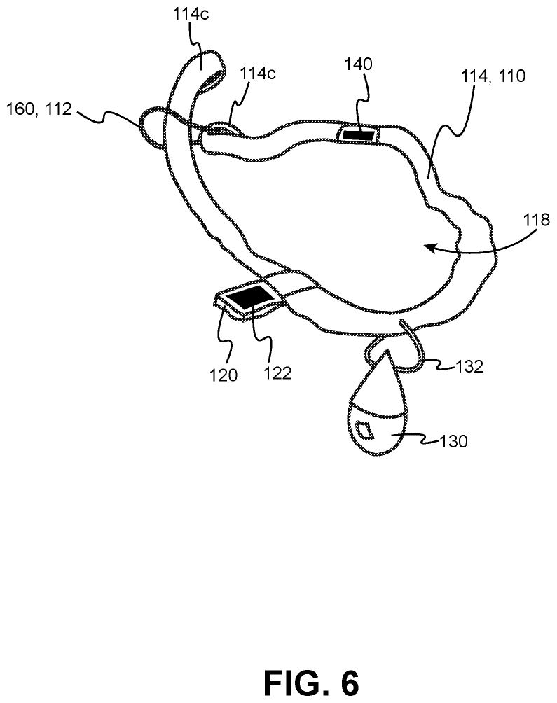

In an embodiment such as shown in FIGS. 5 and 6, the at least one connector element 112 is the single connecter element, and the single connector element 112 is mounted to a first end of the manipulatable member 114. The single connector element 112 is structured to releasably connect to the portion of the manipulatable member 114 that is spaced apart from the first end of the manipulatable member 114 for forming the continuous loop 118 of the connector member 110 from at least part of the manipulatable member 114.

In the specific embodiment shown in FIGS. 4, 5 and 6, the single connector element 112 is a carabiner 160 that is secured through the end loop 114c on the first end of the manipulatable member 114. The carabiner 160 is removably connectable to the manipulatable member 114 for forming the continuous loop 118 of the connector member 110 from the manipulatable member 114.

In an embodiment such as shown in FIG. 4, the indicator apparatus 100 is structured such that it is the connector element 112 which defines the continuous loop 118 of the connector member 110 and that “loops” directly around the rung 104 of the ladder 102 for releasable securing the indicator apparatus 100 to the rung 104 of the ladder 102. Said another way, the at least one connector element 112 includes the first and second ends 110a, 110b of the connector member 110 such that the portion of the connector member 110 that forms the continuous loop 118 is defined on the at least one connector element 112.

In an additional embodiment where the at least one connector element 112 includes the first and second ends 110a, 110b of the connector member 110, and the indicator apparatus 100 is for use on the rung 104 of the ladder 102 positioned proximate the egress point 106 of the building 108, the at least one connector element 112 is sized to fit around the rung 104 of the ladder 102. More specifically, the at least one connector element 112 is sized such that when the first and second ends 110a, 110b of the connector member 110 on the at least one connector element 112 are connected to form the continuous loop 118, the continuous loop 118 of the at least one connector element 112 will fit around the rung 104 of the ladder 102.

In the specific embodiment provided in FIG. 4, the at least one connector element 112 is the carabiner 160 that is secured through the end loop 114c formed in one end of the manipulatable member 114. The first end 110a of the connector member 110 is defined by a nose 162 of the carabiner and the second end 110b of the connector member 110 is defined by a gate 164 of the carabiner 160 such that when the nose 162 and gate 164 of the carabiner 160 are secured together, an internal loop of the carabiner 160 defines the continuous loop 118 of the connector member 110.

In an exemplary embodiment where the egress point 106 is the window 106a, the indicator apparatus 100 is attached to a top rung of the ladder 102 and manipulated so that the indicator light 130 can be placed inside the window. Prior to any entry of firefighters, the manipulatable member 114 is manipulated such that the indicator light 130 hangs down from the window 106a on the manipulatable member 114.

In some embodiments, the manipulatable member 114 is sized such that the indicator light 130 can be placed in the window 106a and hung down at least 35 inches from a bottom ledge of a windowsill of the window 106a, as this distance from the window 106a tends to be where visibility is the clearest. By attaching the indicator apparatus 100 to the ladder 104 in this way, the indicator apparatus 100 will indicate to any firefighter in the interior of the building that not only is there a window 106a located at this position, but there is also the ladder 102 for egress.

As discussed above, some embodiment of the indicator apparatus 100 are structured for use on the door knob or door handle 150, where the indicator apparatus 100 can be looped around the doorknob or door handle 150 for indicating entry and exit points or rooms within a building, or egress points from the building itself.

In an embodiment such as shown in FIG. 9, the continuous loop 118 of the connector member 110 of the indicator apparatus 100 is formed to be looped around the door knob or door handle 150 for securing the indicator apparatus 100 thereto.

In an alternative embodiment of the indicator apparatus 100 where the releasable securing element 120 is positioned along the manipulatable member 114 such that the manipulatable member 114 includes the first looped segment (L1) in the stowage configuration and the second looped segment (L2) in the use configuration, the releasable securing element 120 is further positioned such that both of the first and second looped segments (L1), (L2) can be directly looped around the door knob or door handle 150. In this embodiment, the first and second looped segments (L1), (L2) are either sized to be directly looped around the door knob or door handle 150 (i.e., without separating the at least connector element 112 such that the continuous loop 118 becomes non-continuous), or are sized to be looped around the door knob or door handle 150 through separating the first and second ends 110a, 110b of the connector member 110 such that the continuous loop 118 becomes non-continuous, and then connecting the first and second ends 110a, 110b of the connector member 110 around the door knob or door handle 150.

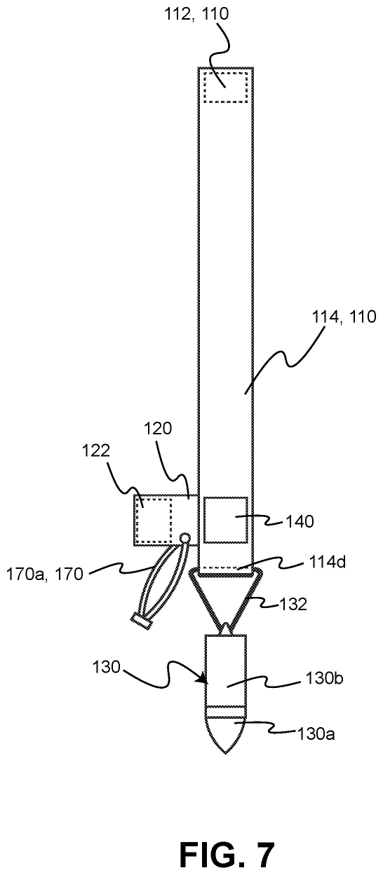

In an alternate embodiment of the indicator apparatus shown in FIG. 7, the indicator apparatus 100 includes a tertiary loop structure 170 that is formed to be looped around the door knob or door handle 150 for securing the indicator apparatus 100 thereto.

In the specific embodiment provided in FIG. 7, the indicator apparatus 100 includes a cinchable loop 170a that is attached to one of the connector member 110 and the releasable securing element 120. The tertiary loop structure 170 of the indicator apparatus 100 is defined by the cinchable loop 170a, and the cinchable loop 170a is sized to be fit over and secured around the door knob and/or the door handle 150 of the building 108.

The indicator apparatus 100 as disclosed herein provides a versatile tool that can help firefighters address critical safety concerns during a fire. The indicator apparatus 100 can be used in a variety of situations to address these critical safety concerns.

The specific embodiments described above have been shown by way of example, and it should be understood that these embodiments may be susceptible to various modifications and alternative forms. It should be further understood that the above-described embodiments are intended to be examples of the present disclosure and alterations and modifications may be affected thereto, by those of skill in the art, without departing from the scope of the disclosure that is defined solely by the claims appended hereto.

What is claimed is:

1. An indicator apparatus that is used for indicating an egress point of a building, the indicator apparatus comprising
a connector member that includes a first end and a second end that is releasably connectable to the first end for forming a continuous loop from at least a portion of the connector member, at least part of the connector member being manipulatable between a stowage configuration where the connector member has a first length, and a use configuration where the connector member has a second length that is greater than the first length;
a releasable securing element that is connected to the connector member for securing the at least part of the connector member in the stowage configuration; and
an indicator light that is connected to the connector member for indicating the position of the egress point.

2. The indicator apparatus of claim 1, wherein the connector member includes a securing part that positioned along the length of the connector member, away from the releasable securing element; and wherein the releasable securing element is releasably connectable to the securing part for securing the part of the connector member in the stowage configuration.

3. The indicator apparatus of claim 1, wherein the connector member includes at least one connector element and a manipulatable member, wherein the at least part of the connector member that is manipulatable between the stowage and use configurations is the manipulatable member.

4. The indicator apparatus of claim 3, wherein the manipulatable member is composed of a length of a manipulatable material that is formed as one of a strap, a belt, or a rope.

5. The indicator apparatus of claim 3, wherein the at least one connector element includes the first and second ends of the connector member such that the portion of the connector member that forms the continuous loop is defined on the at least one connector element.

6. The indicator apparatus of claim 5, wherein the indicator apparatus is for use on a ladder that is positioned proximate the egress point of the building; and
wherein the at least one connector element is sized such that when the first and second ends of the connector member on the at least one connector element are connected to form the continuous loop, the continuous loop of the at least one connector element will fit around a rung of the ladder.

7. The indicator apparatus of claim 6, wherein the at least one connector element is a carabiner; and wherein the first end of the connector member is defined by a nose of the carabiner and the second end of the connector member is defined by a gate of the carabiner.

8. The indicator apparatus of claim 1, further comprising a cinchable loop that is attached to one of the connector member and the releasable securing element, wherein the cinchable loop is sized to be fit over and secured around a doorknob and/or a doorhandle of the building.

9. The indicator apparatus of claim 3, wherein the first and second ends of the connector member are defined on opposing ends of the manipulatable member; and
wherein the at least one connector element is connected to at least one of the opposing ends of the manipulatable member for releasably connecting the opposing ends of the manipulatable member when forming the continuous loop of the connector member.

10. The indicator apparatus of claim 9, wherein the at least one connector element is a single connecter element that is mounted to a first end of the manipulatable member of the connecter member and that is structured to releasably connect to a portion of the manipulatable member that is spaced apart from the first end of the manipulatable member for forming the continuous loop of the connector member from at least part of the manipulatable member.

11. The indicator apparatus of claim 9, wherein the releasable securing element is positioned on the connector member such that when the opposing ends of the manipulatable member are connected and the manipulatable member is in the stowage configuration, the form of the manipulatable includes a first looped segment, and when the opposing ends of the manipulatable member are connected and the manipulatable member is in the use configuration, the form of the form of the manipulatable includes a second looped segment having a size that is greater than a size of the first looped segment.

12. The indicator apparatus of claim 11, wherein the manipulatable member of the connector member is structured such that in the use configuration, the entirety of the manipulatable member defines the continuous loop of the connector member, and the second looped segment is defined by the entirety of the continuous loop of the connector member.

13. The indicator apparatus of claim 11, wherein the releasable securing element is positioned on the connector member such that in the stowage configuration, the opposing ends of the manipulatable member are positioned along the first looped segment of the manipulatable member, and in the use configuration, the first and second ends of the manipulatable member are positioned along the second looped segment of the connector member.

14. The indicator apparatus of claim 13, wherein the indicator apparatus is for use on a ladder that is positioned proximate the egress point of the building; and
wherein the releasable securing element is positioned on the connector member such that in the stowage configuration, the first looped segment of the manipulatable member will fit around a rung of the ladder, and in the use configuration, the second looped segment of the manipulatable member will also fit around the rung of the ladder.

15. The indicator apparatus of claim 11, wherein the at least one connector element includes a first connector positioned proximate the first end of the manipulatable member and a second connector positioned proximate the second end of the manipulatable member.

16. The indicator apparatus of claim 1, further comprising a rigid looped member that is attached to the connector member, wherein the indicator light is connected to the connector member loop via the rigid looped member.

17. The indicator apparatus of claim 2, wherein the releasable securing element is a Velcro securing flap and the securing part is a length of Velcro.

18. The indicator apparatus of claim 1, wherein the indicator light is detachable from the connector member.

19. An indicator apparatus for placing through an egress point of a building to indicate the location of at least one person therewithin, the indicator apparatus comprising
a connector member that includes a first end and a second end that is releasably connectable to the first end for forming a continuous loop from at least a portion of the connector member, at least part of the connector member being manipulatable between a stowage configuration where the connector member has a first length, and a use configuration where the connector member has a second length that is greater than the first length;
a releasable securing element that is connected to the connector member for securing the at least part of the connector member in the stowage configuration; and
an indicator light that is connected to the connector member for indicating the position of the egress point.
